(19) United States
(12) Patent Application Publication
(10) Pub. No.: US 2025/0106345 A1
(43) Pub. Date: Mar. 27, 2025

(54) A METHOD, APPARATUS, DEVICE, AND STORAGE MEDIUM FOR MEDIA CONTENT GENERATION

(71) Applicant: Beijing Zitiao Network Technology Co., Ltd., Beijing (CN)

(72) Inventor: Aoyu Wang, Beijing (CN)

(21) Appl. No.: 18/898,273

(22) Filed: Sep. 26, 2024

(30) Foreign Application Priority Data
Sep. 27, 2023 (CN) 202311267784.X

(51) Int. Cl. H04N 5/262; G06T 17/00

(52) U.S. Cl. CPC H04N 5/262; G06T 17/00

(57) ABSTRACT

According to embodiments of the disclosure, a method, apparatus, device and storage medium for media content generation are provided. The method includes: obtaining, based on input information indicating a target object, appearance information of the target object, the appearance information at least indicating a shape and a posture of the target object; receiving a description text related to a particle display effect; determining, based on the description text, configuration information for particle display of the target object; and generating, based on the appearance information and the configuration information, a media content comprising a particle effect of the target object. In this way, a particle effect may be generated based on simple input information and description text. This advantageously reduces the difficulty of generation of the particle effect, thereby helping to produce a richer particle effect.

### CROSS-REFERENCE TO RELATED APPLICATION

This application claims priority to Chinese patent application No. 202311267784.X, filed on Sep. 27, 2023 and entitled “A METHOD, APPARATUS, DEVICE, AND STORAGE MEDIUM FOR MEDIA CONTENT GENERATION”, which is incorporated herein by reference in its entirety.

### FIELD

Example embodiments of the present specification relate generally to the field of computer and, specifically, to a method, apparatus, device, and computer-readable storage medium for media content generation.

### BACKGROUND

With the development of computer technologies, more and more applications are designed to provide various services to user. For example, a user may browse, comment, and repost various types of content in an application, including various media content such as videos, images, image sets, audio, and the like. The user may also add particular elements (e.g., effects) in the media content through some operations. Such particular elements may be any suitable element (e.g., an animal, a scene, an item, etc.). In addition, such a particular element may be a static element or a dynamic element, and also may be a two-dimensional element or a three-dimensional element.

### SUMMARY

In a first aspect of the present disclosure, a method of media content generation is provided. The method comprises: obtaining, based on input information indicating a target object, appearance information of the target object, the appearance information at least indicating a shape and a posture of the target object; receiving a description text related to a particle display effect; determining, based on the description text, configuration information for particle display of the target object; and generating, based on the appearance information and the configuration information, a media content comprising a particle effect of the target object.

In a second aspect of the present disclosure, an apparatus for media content generation is provided. The apparatus comprises: an information obtaining module configured to obtain, based on input information indicating a target object, appearance information of the target object, the appearance information at least indicating a shape and a posture of the target object; a text receiving module configured to receive a description text related to a particle display effect; an information determining module configured to determine, based on the description text, configuration information for particle display of the target object; and a content generating module configured to generate, based on the appearance information and the configuration information, a media content comprising a particle effect of the target object.

In a third aspect of the present disclosure, an electronic device is provided. The device comprises at least one processing unit; and at least one memory coupled to the at least one processing unit and storing instructions for execution by the at least one processing unit, the instructions, when executed by the at least one processing unit, causing the electronic device to perform the method of the first aspect.

In a fourth aspect of the present disclosure, a computer-readable storage medium is provided. The computer-readable storage medium has a computer program stored thereon, the computer program being executable by a processor to implement the method of the first aspect.

It would be appreciated that the content described in the section is neither intended to identify the key features or essential features of the present disclosure, nor is it intended to limit the scope of the present disclosure. Other features of the present disclosure will be readily understood through the following description.

### BRIEF DESCRIPTION OF DRA WINGS

The above and other features, advantages and aspects of the various embodiments of the present disclosure will become more apparent in combination with the accompanying drawings and with reference to the following detailed description. In the drawings, the same or similar reference symbols refer to the same or similar elements, wherein:

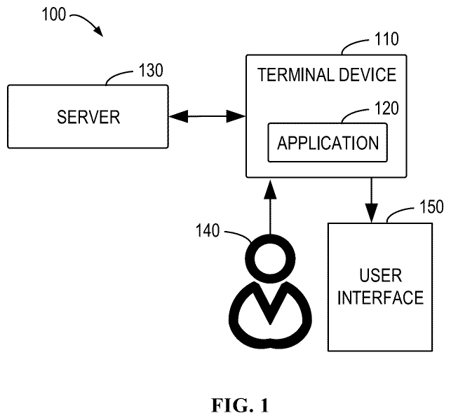

FIG. 1 illustrates a schematic diagram of an example environment in which embodiments of the present disclosure can be implemented;

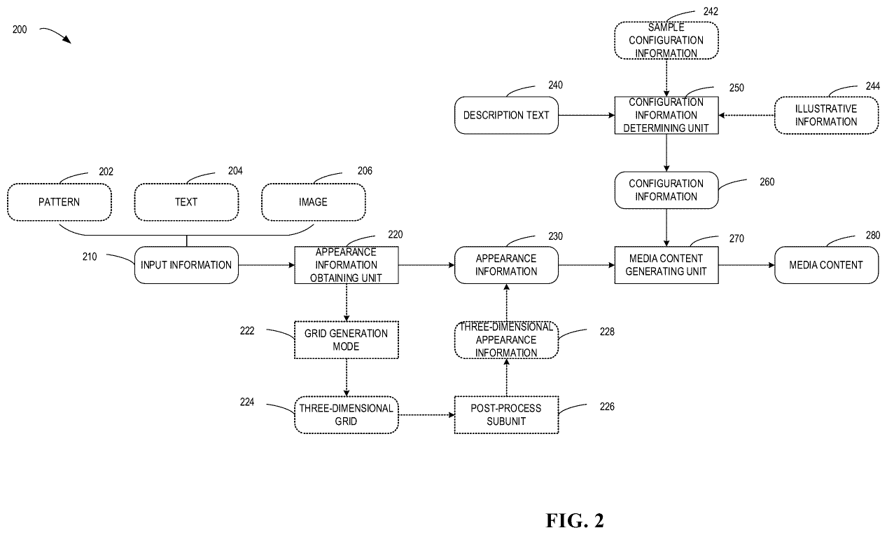

FIG. 2 illustrates a schematic diagram of an example architecture for media content generation according to some embodiments of the present disclosure;

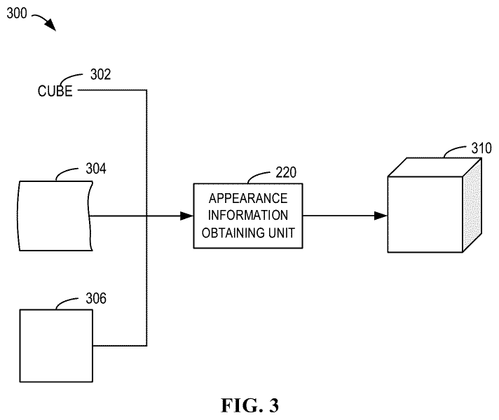

FIG. 3 illustrates a schematic diagram of an example of obtaining appearance information according to some embodiments of the present disclosure;

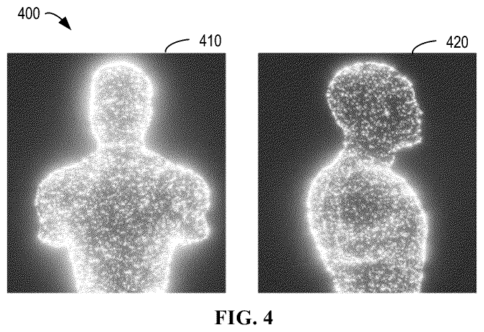

FIG. 4 illustrates a schematic diagram of an example particle effect according to some embodiments of the present disclosure;

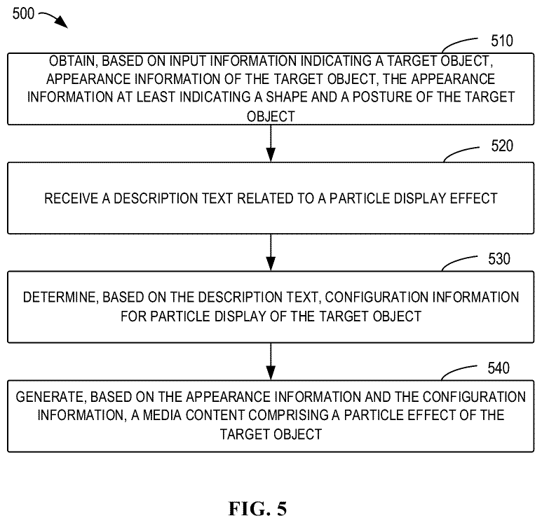

FIG. 5 illustrates a flowchart of a process for media content generation according to some embodiments of the present disclosure;

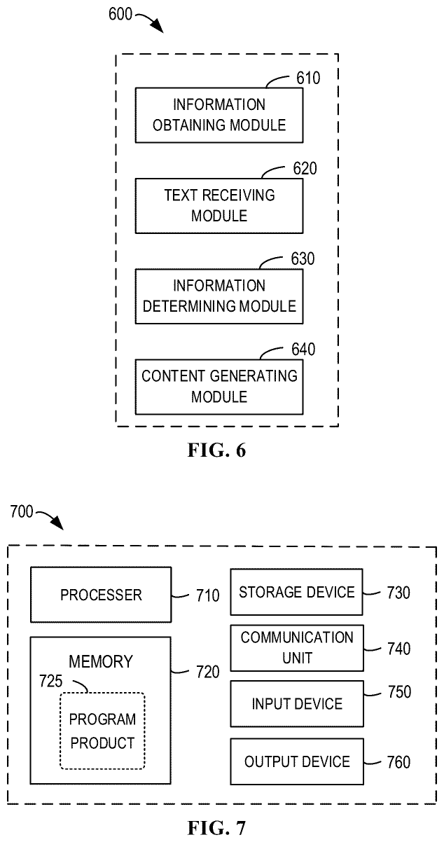

FIG. 6 illustrates a schematic structural block diagram of an apparatus for media content generation according to some embodiments of the present disclosure; and

FIG. 7 illustrates a block diagram of an electronic device in which one or more embodiments of the present disclosure may be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure can be implemented in various forms and should not be interpreted as limited to the embodiments described in this specification. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

In the description of the embodiments of the present disclosure, the term ‘including’, and similar terms would be appreciated as open inclusion, i.e., “including but not limited to”. The term ‘based on’ would be appreciated as ‘at least partially based on’. The term “one embodiment” or ‘the embodiment’ would be appreciated as “at least one embodiment”. The term “some embodiments” would be appreciated as ‘at least some embodiments’. Other explicit and implicit definitions may also be included below. The terms ‘first’, ‘second’, etc. may refer to different or identical objects. The following may also include other explicit and implicit definitions.

The term ‘in response to’ indicates the occurrence of a corresponding event or the satisfaction of a condition. It will be understood that the timing of the execution of a subsequent action that is executed in response to that event or condition is not necessarily strongly correlated with the time when the event occurs, or the condition is satisfied. In some cases, the subsequent action may be executed immediately upon the occurrence of the event or the establishment of the condition; in other cases, the subsequent action may be executed sometime after the occurrence of the event or the establishment of the condition.

Embodiments of the present disclosure may involve user data, obtaining and/or using data, etc. These aspects are subject to appropriate laws and regulations and related provisions. In embodiments of the present disclosure, all data collection, obtaining, processing, processing, reposting, use, and the like are carried out on the premise of the knowledge and confirmation of the user. Accordingly, in implementing the embodiments of the present disclosure, the type of data or information that may be involved, the scope of use, the use scenarios, etc., shall be notified to the user and the authorization of the user shall be obtained in an appropriate manner in accordance with the relevant laws and regulations. The specific manner of informing and/or authorizing may vary according to the actual situation and application scenario, and the scope of the present disclosure is not limited in this regard.

If the solutions described in this specification and the implementation examples involve the processing of personal information, they will be processed on the premise of having a basis of legality (e.g., with the consent of the subject of the personal information, or necessary for the fulfillment of a contract, etc.), and they will be processed only within the scope of the stipulations or agreements. The refusal of the user to process personal information other than that which is necessary for the basic functions will not affect the use of the basic functions.

As used herein, the term ‘model’ can learn a correlation between a corresponding input and an output from the training data, so that a corresponding output can be generated for a given input after training is completed. Model generation can be based on a machine learning technique. Deep learning is a machine learning algorithm that processes inputs and provides corresponding outputs by using a multi-layer processing unit. In this document, a “model” may also be referred to as a “machine learning model”, a ‘machine learning network’, or a ‘network’. These terms are used interchangeably herein. A model may in turn include different types of processing units or networks.

FIG. 1 illustrates a schematic diagram of an example environment 100 in which embodiments of the present disclosure can be implemented. In this example environment 100, an application 120 is installed in a terminal device 110. A user 140 may interact with the application 120 via the terminal device 110 and/or an attachment device of the terminal device 110. The application 120 may be a social application, a content sharing application, a shopping application, or any other suitable application.

In the environment 100 of FIG. 1, if the application 120 is in an active state, the terminal device 110 may display a user interface 150 of the application 120. The user interface 150 may include various types of interfaces that can be provided by the application 120, such as a content display interface, a content creation interface, a content release interface, a message interface, a personal home page, and the like.

In some embodiments, the terminal device 110 displays the media content including the particular element at the user interface 150. For example, the user interface 150 may be a live streaming interface of a live streaming room. The audience user can interact with the live streamer user in a variety of ways through the live streaming interface. The terminal device 110 may, in response to receiving a gift-sending operation from a user, display a live stream content including a gift-sending effect on the live stream interface. The particular element in this specification may be generated in advance or may be generated in real time when the media content including the particular element is generated. That is, when the media content including the particular element is generated, the media content including the particular element may be directly generated with the pre-generated particular element and the media content, or the particular element may be generated based on a user input, and then the media content including the particular element is generated based on the particular element and the media content.

The media content including the particular element herein may be generated in real time or may be generated in advance and stored in the terminal device 110 and/or in the server 130. The media content including the particular element may be generated locally by the terminal device 110 or may be generated by the server 130.

In some embodiments, the terminal device 110 communicates with the server 130 to implement provisioning of services to the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a ‘wearable’ circuit, etc.). The server 130 may be various types of computing systems/servers capable of providing computing power, including, but not limited to, mainframes, edge computing nodes, computing devices in a cloud environment, and the like.

It should be understood that the structures and functions of the various elements in the environment 100 are described for exemplary purposes only and do not imply any limitation to the scope of the present disclosure.

As mentioned above, the user may also add a particular element in the media content through some operations. That is, in response to the user input, the electronic device may generate a media content including the particular element. In this specification, the particular element may be, for example, a particle effect (which may also be referred to as firework), and the particle effect is usually a three-dimensional element.

Traditionally, a particle effect is typically pre-generated by a professional (e.g., an effect designer) using a digital content creation (DCC) tool. The media content including the particle effect is the media content generated based on a pre-generated particle effect. The generation of the media content including a particle effect, especially the generation of a particle effect, requires a lot of manpower and a higher technical threshold. In addition, a traditional particle effect is often relatively single, which may affect the user experience when generating a media content including a particle effect by the user.

In this regard, embodiments of the present disclosure provide a media content generation solution. According to the solution, appearance information of the target object is obtained based on input information indicating a target object, the appearance information at least indicating a shape and a posture of the target object. Based on a received description text related to a particle display effect, configuration information for particle display of the target object is determined based on the description text. Based on the appearance information and the configuration information, a media content comprising a particle effect of the target object is generated.

According to the embodiment of the present disclosure, the user can obtain a more complex particle effect by simply indicating description information of the target object and the description text related to the particle display effect, and thus obtain a media content including the particle effect of the target object. In this way, a particle effect may be generated based on simple input information and description text. This advantageously reduces the difficulty of generation of the particle effect, thereby helping to produce a richer particle effect. Further, with embodiments of the present disclosure, a rich visual effect can be provided, which helps to enhance the interactivity and interest during the interaction, thereby improving the interactive experience of the user.

Some example embodiments of the present disclosure will be described below with continued reference to the accompanying drawings.

FIG. 2 illustrates a schematic diagram of an example architecture 200 for media content generation according to some embodiments of the present disclosure. The architecture 200 may be implemented at a terminal device (e.g., the terminal device 110), at a server (e.g., the server 130), or partially at a terminal device and partially at a server. For ease of description, the terminal device 110 and the server 130 are collectively referred to as an electronic device hereinafter, i.e., the architecture 200 is implemented at the electronic device. In addition, the user described below may be a terminal user (e.g., a user of the application 120), a user performing effect manufacturing, or any other user.

As shown in FIG. 2, the architecture 200 includes an appearance information obtaining unit 220, a configuration information determining unit 250, and a media content generating unit 270. The appearance information obtaining unit 220 is configured to obtain, based on input information 210 indicating a target object, appearance information 230 of the target object, the appearance information 230 at least indicating a shape and a posture of the target object. In some embodiments, the appearance information 230 may also indicate a texture (e.g., color) of the target object. For example, if the input information 210 includes or indicates the texture of the target object, the appearance information 230 may indicate the texture of the target object.

The input information 210 may be information input by the user in real time or may be information pre-input by the user and stored in the electronic device. In some embodiments, the input information 210 includes description information related to the appearance of the target object.

The description information may include, for example, a pattern 202 depicting the target object. The pattern includes one or more lines. The pattern herein may be any pattern, such as a simple stroke.

The description information may include, for example, a text 204 describing the target object. The text 204 herein may be any suitable character of any language (for example, Chinese, English, etc.), any text length (for example, may be 3 words, 5 words, etc.). For example, if the target object is a rabbit, the text may be, for example, “one rabbit”.

The description information may also include, for example, an image 206 (e.g., an image including a target object) indicating the target object. This image may be any format, any color (e.g., a black and white image, an RGB color image, a grayscale image, etc.), an image of any size. In order to ensure that the appearance information obtaining unit 220 may generate more accurate appearance information of the target object based on the image included in the input information 210, the subject in this image should be the target object, and there should be as few other object as possible in the image.

The appearance information obtaining unit 220 may obtain the appearance information 230 of the target object at least based on the description information included in the input information 210. The appearance information 230 may be represented in any suitable form, such as a grid, a neural radiation field, or the like. Since subsequently generated particle effects are usually three-dimensional effects, in some embodiments, the appearance information obtaining unit 220 may obtain, based on at least the description information, the appearance information 230 represented by the three-dimensional grid of the target object (i.e., obtain three-dimensional appearance information of the three-dimensional grid redisplay of the target object). The three-dimensional grid is composed of polygons formed by a neighboring point cloud of objects, usually consisting of triangles, quadrilaterals, or other simple convex polygons.

FIG. 3 illustrates a schematic diagram 300 of an example of obtaining appearance information according to some embodiments of the present disclosure. As shown in FIG. 3, if the target object is a cube, the appearance information obtaining unit 220 may obtain the appearance information 310 of the cube based on the characters 302 (e.g., cube), the pattern 304, or the image 306 included in the description information.

With respect to the specific manner in which the appearance information obtaining unit 220 obtains the appearance information 230, in some embodiments, the appearance information obtaining unit 220 may also obtain an appearance information base. The appearance information base may include a plurality of appearance information corresponding to a plurality of preset objects. The appearance information obtaining unit 220 may query the appearance information base for appearance information matching the description information. If the description information matching the description information is queried, the appearance information obtaining unit 220 may obtain the description information from the appearance information base and determine the description information as the appearance information 230. For example, if the description information is a text, the appearance information obtaining unit 220 may perform a semantic analysis on the text to determine appearance information from the appearance database that matches the results of the analysis. If the description information is a pattern or an image, the appearance information obtaining unit 220 may determine a matching degree between the pattern/image and a plurality pieces of appearance information included in the appearance database, and determine one piece of appearance information whose matching degree is higher than a matching degree threshold and corresponds to the highest matching degree as the appearance information that matches the pattern/image. For example, the appearance information obtaining unit 220 may perform semantic analysis on the text with a trained machine learning model or determine the matching degree.

In some embodiments, the appearance information obtaining unit 220 may further generate initial appearance information represented by a three-dimensional grid 224 of the target object by using a grid generation model 222 corresponding to the type of the description information. For example, if the description information is a pattern/image, the grid generation model 222 may be a trained image processing model. If the description information is a text, the grid generation model 222 may be a trained multimodal model, which may output three-dimensional grid data corresponding to the text based on the input text. In some embodiments, the initial appearance information may be directly determined as appearance information 230. Alternatively, or in addition, in order to improve the quality of the appearance information, in some embodiments, the appearance information obtaining unit 220 further includes a post-process subunit 226.

The post-process subunit 226 is configured to perform one or more post-processes associated with the content creation on the initial appearance information represented by the three-dimensional grid 224. The one or more post-processes may include, for example, at least one of performing a heavy topology, reducing, smoothing, or the like. In some embodiments, the post-process subunit 226 may perform one or more preset post-processes on the initial appearance information represented by the three-dimensional grid 224.

In some embodiments, the post-process performed may be specified by a user. For example, the post-process subunit 226 may also display options for candidate post-processes associated with content creation, the candidate post-processes comprising the one or more post-processes. For example, the post-process subunit 226 may display options of candidate post-process through a display screen of the electronic device. The post-process subunit 226 may receive user input indicating one or more post-processes and perform one or more post-processes on the initial appearance information in response to the user input. The user input herein may indicate which post-process to perform, for example. For example, the user input may indicate to perform a smoothing operation. The user input herein may also indicate, for example, a parameter of post-process to be performed, which parameter may indicate, for example, the degree to which the post-process is performed. For example, the user input may indicate to perform a smoothing operation and the degree to which the smoothing operation is performed is 50%.

After post-process the initial appearance information, the post-process subunit 226 may output three-dimensional appearance information 228 being the initial appearance information after post-processed. The appearance information obtaining unit 220 may determine the three-dimensional appearance information 228 as the appearance information 230.

Example embodiments of obtaining appearance information 230 in the case that the input information 210 is description information as described above. In some embodiments, the appearance information base may be obtained and maintained in advance, including pre-generated appearance information of a plurality of candidate object, for example, appearance information of various animals. In such embodiments, the input information 210 may specify one or more of the plurality of candidate object as the target object. Accordingly, the appearance information of the specified candidate object stored in the appearance information base may be determined as the appearance information 230.

In addition to the input information 210, the electronic device may also receive a description text 240 related to a particle display effect. The description text 240 represents a desired particle display effect in natural language. The description text 240 is provided to the configuration information determining unit 250. The configuration information determining unit 250 may determine, based on the description text 240, configuration information 260 for particle display of the target object. Specifically, the configuration information determining unit 250 may obtain a set of configuration parameters for the particle display effect.

The set of configuration parameters may include, for example, at least one of the following: the number of particles, a size of a single particle, a duration of a particle being displayed, a mass of a particle, a color of a particle, a degree of luminescence of a particle, a size of a luminous area of a particle, or a duration of the particle display effect in the media content, and the like. It may be understood that the set of configuration parameters may further include more suitable parameters for the particle display effect, which is not limited in the present disclosure.

The configuration information determining unit 250 may further determine, by performing a semantic analysis on the description text 240, a parameter value of at least one configuration parameter in the set of configuration parameters. The configuration information determining unit 250 may, for example, perform semantic analysis on the description text 240 by using a trained machine learning model (for example, a language model (LM)) configured for semantic analysis to obtain the semantics corresponding to the description text 240. Alternatively, or in addition, the configuration information determining unit 250 may further obtain the semantics corresponding to the description text 240 by using a pre-obtained semantic analysis rule, for example.

Regarding the specific method of determining a parameter value of the at least one configuration parameter, in some embodiments, the configuration information determining unit 240 may recognize the text related to the parameter in the description text 240 based on the trained machine learning model. The configuration information determining unit 240 may further determine, according to a predefined mapping rule, a value corresponding to the text related to the parameter. For example, if the machine learning model recognizes that the number of words is ‘generally many,’ the configuration information determining unit 240 may determine, based on the mapping rule, that ‘more generally’ semantically corresponds to medium, then the number of particles is medium number.

In some embodiments, the configuration information determining unit 240 may, for example, obtain sample configuration information 242 for particle display, which may also be referred to as a configuration information template. The sample configuration information 242 may include, for example, corresponding sample parameter values of the set of configuration parameters.

The configuration information determining unit 240 may further obtain illustrative information 244 for a set of configuration parameters, for example. The illustrative information 244 may, for example, indicate a corresponding meaning of a set of configuration parameters in a natural language. When the set of configuration parameters includes a numerical type parameter whose parameter value is a numerical value, the illustrative information 244 may include, for example, at least one of the following: a value range of the parameter value of the numerical parameter, or text semantics corresponding to a plurality of different parameter values of the numerical parameter.

The configuration information determining unit 240 may, in turn, generate, by using a machine learning model configured for semantic analysis, a parameter value of the at least one configuration parameter based on the description text 240, the sample configuration information 242, and the illustrative information 244.

By way of example, Table 1 illustrates an example of the description text 240, the sample configuration information 242, and the illustrative information 244 obtained by the configuration information determining unit 240, wherein the sample configuration information 242 includes configuration parameters and corresponding sample parameter values.

TABLE 1

| | | Sample |
|---|---|---|
| | Configuration Parameter | Parameter Value |
| Sample | the number of particles | 5000 |
| Configuration | a size of a single particle | 10 |
| Information | a duration of a particle being | 50 |
| | displayed | |
| | a mass of a particle | 15 |
| | a color of a particle | |
| | a degree of luminescence of a | 0.5 |
| | particle | |
| | a size of a luminous area of a | 8 |
| | particle | |
| | a duration of the particle display | 200 |
| | effect in the media content | |

| | |
|---|---|
| Illustrative | A parameter value of 1000 for the number of |
| Information | particles is considered small, and 20,000 is |
| | considered large. A parameter value of 2 for a |
| | size of a single particle is considered small, |
| | 20 is considered large. A parameter value of |
| | 20 for a duration of a particle being displayed |
| | (i.e., the length of a life of a particle) is |
| | considered small, and 200 is considered large. |
| | A parameter value of 1 for a mass of a particle |
| | is considered small, 50 is considered large. A |
| | parameter value of a color of a particle can be |
| | described, for example, in hexadecimal. |
| | A parameter value of a degree of luminescence |
| | of a particle is 0 for nothing and 1.0 for |
| | maximum. A size of a luminous area of a particle |
| | (i.e. a luminous block of a particle) has a |
| | parameter value ranging from 0 to 20. |
| | A duration of the particle display effect |
| | in the media content (i.e. the number of |
| | frames to be rendered) has a parameter |
| | value of 200, with a maximum value of |
| | 500 and a minimum value of 50. I will give |
| | you a description, please help me |
| | generate data with the same structure as the |
| | sample configuration information above. |
| Description | For example: Golden yellow particles, |
| Text | average number of particles, slightly |
| | luminescent, very heavy effect |

The configuration information determining unit 240 may provide the description text 240, the sample configuration information 242, and the illustrative information 244 shown in Table 1 to the machine learning model. The machine learning model may in turn output corresponding parameter values for the set of configuration parameters.

Table 2 shows configuration information 260 generated by configuration information determining unit 240 based on description text 240, sample configuration information 242, and illustrative information 244 shown in Table 1. Specifically, Table 2 shows the configuration parameters and corresponding parameter values.

TABLE 2

| Configuration Parameter | Parameter Value |
|---|---|
| the number of particles | 10000 |
| a size of a single particle | 10 |
| duration of a particle being | |
| a duration of a particle being | 100 |
| displayed | |
| a mass of a particle | 50 |
| a color of a particle | FFFF00 |
| a degree of luminescence of a | 0.2 |
| particle | |
| a size of a luminous area of a particle | 8 |
| a duration of the particle display | 200 |
| effect in the media content | |

The configuration information shown in Table 2 may indicate that the number of particles is 10000, the size of the single particle is 10, the duration of the particle being displayed is 100 frames, the mass of the particle is 50, the color of the particle is golden yellow (FFFF00), the degree of luminescence of the particle is 0.2, the size of a luminous area of the particles is 8, and the duration of the particle display effect in the media content is 200 frames. It should be understood that the parameter values shown in Table 2 are for example only and are not intended to limit the scope of the present disclosure.

It should be understood that the configuration of the particle display may include a plurality of parameters. In some embodiments, the description text 240 input by the user may only involve a part of these parameters. For those parameters that are not described in the description text 240, either a predetermined value or a default value can be used.

The appearance information 230 and the configuration information 260 are provided together to the media content generating unit 270. The media content generating unit 270 is configured to generate, based on the appearance information 230 and the configuration information 260, a media content 280 comprising a particle effect of the target object. Specifically, the media content generating unit 270 may generate the particle effect of the target object based on the appearance information 230 and the configuration information 260. The particle effect of the target object at least partially matches the shape and pose indicated by the appearance information 230. FIG. 4 illustrates a schematic diagram 400 of an example particle effect according to some embodiments of the present disclosure. If the target object is a body portrait, as shown in FIG. 410 and FIG. 420 in FIG. 4, the particle effect is a three-dimensional effect for the target object. The particle effect generated by the media content generating unit 270 may be, for example, a dynamic effect, such as an effect of firework. The particle effect generated by the media content generating unit 270 may be, for example, a moving picture, a video, or the like. The diagram 410 shown in FIG. 4 and FIG. 420 may be, for example, some two frame images in a video of a particle effect generated by the media content generating unit 270.

The media content generating unit 270, in turn, generates the media content 280 including a particle effect of the target object based on the particle effect. By way of example, the media content generating unit 270 in turn generates the media content 280 including a particle effect of the target object based on the particle effect and the pre-obtained DCC template, which the media content 280 may be, for example, dual-channel. The dual-channel media content whose left side may for example describe transparency and whose right side may for example describe color.

The production efficiency of otherwise complex particle special effects can be improved with embodiments of the present disclosure, thereby accelerating the output of corresponding media content. In addition, users who wish to create particle effects only need to perform simple inputs without having to master complex DCC tools. This advantageously lowers the threshold for the production of particle special effects.

Specific details of the various steps of media content generation have been described above, providing a method of media content generation. FIG. 5 illustrates a flowchart of a process 500 for media content generation according to some embodiments of the present disclosure. The process 500 may be implemented at the terminal device 110 and/or the server 130, which is hereinafter referred to as an electronic device to refer to the terminal device 110 and/or the server 130 implementing the process 500. The process 500 is described below with reference to FIG. 1.

At block 510, the electronic device obtains, based on input information indicating a target object, appearance information of the target object, the appearance information at least indicating a shape and a posture of the target object.

At block 520, the electronic device receives a description text related to a particle display effect.

At block 530, the electronic device determines, based on the description text, configuration information for particle display of the target object.

At block 540, the electronic device generates, based on the appearance information and the configuration information, a media content comprising a particle effect of the target object.

In some embodiments, determining the configuration information comprises: obtaining a set of configuration parameters for the particle display effect; and determining, by performing a semantic analysis on the description text, a parameter value of at least one configuration parameter in the set of configuration parameters.

In some embodiments, determining the parameter value of at least one configuration parameter of the set of configuration parameters comprises: obtaining sample configuration information for particle display, the sample configuration information comprising corresponding sample parameter values of the set of configuration parameters; obtaining illustrative information for the set of configuration parameters, the illustrative information indicating corresponding meanings of the set of configuration parameters in natural language; and generating, by using a machine learning model configured for semantic analysis, a parameter value of the at least one configuration parameter based on the sample configuration information, the illustrative information, and the description text.

In some embodiments, the set of configuration parameters comprises a numerical parameter having a parameter value of numerical value, and the illustrative information comprises at least one of the following: a value range of the parameter value of the numerical parameter, or text semantics corresponding to a plurality of different parameter values of the numerical parameter.

In some embodiments, the set of configuration parameters comprises at least one of the following: the number of particles, a size of a single particle, a duration of a particle being displayed, a mass of a particle, a color of a particle, a degree of luminescence of a particle, a size of a luminous area of a particle, or a duration of the particle display effect in the media content.

In some embodiments, the input information comprises description information related to an appearance of the target object, and obtaining the appearance information of the target object comprises: receiving the description information; and generating, based at least on the description information, three-dimensional appearance information of the target object represented by a three-dimensional grid.

In some embodiments, generating the three-dimensional appearance information comprises: generating initial appearance information of the target object represented by a three-dimensional grid by using a grid generation model corresponding to the type of the description information; performing one or more post-processes associated with content creation on the initial appearance information; and determining post-processed initial appearance information as the three-dimensional appearance information.

In some embodiments, performing one or more post-processes associated with content creation on the initial appearance information comprises: displaying options for candidate post-processes associated with content creation, the candidate post-processes comprising the one or more post-processes; receiving a user input indicating the one or more post-processes; and in response to the user input, performing the one or more post-processes on the initial appearance information.

In some embodiments, the description information comprises at least one of the following: a pattern depicting the target object, the pattern comprising one or more lines, characters describing the target object, or an image comprising the target object.

According to some embodiments of the present disclosure, an apparatus for media content generation is further provided. FIG. 6 is a schematic structural block diagram of an apparatus 600 for media content generation according to some embodiments of the present disclosure. The apparatus 600 may be implemented or included in the terminal device 110 and/or the server 130. The various modules/components in the apparatus 600 may be implemented by hardware, software, firmware, or any combination thereof.

As shown in the figure, the apparatus 600 includes an information obtaining module 610 configured to obtain, based on input information indicating a target object, appearance information of the target object, the appearance information at least indicating a shape and a posture of the target object. The apparatus 600 further includes a text receiving module 620 configured to receive a description text related to a particle display effect. The apparatus 600 further includes an information determining module 630 configured to determine, based on the description text, configuration information for particle display of the target object. The apparatus 600 further includes a content generating module 640 configured to generate, based on the appearance information and the configuration information, a media content comprising a particle effect of the target object.

In some embodiments, the information determining module 630 includes: a configuration parameter obtaining module configured to obtain a set of configuration parameters for the particle display effect; and a parameter value determining module configured to determine, by performing a semantic analysis on the description text, a parameter value of at least one configuration parameter in the set of configuration parameters.

In some embodiments, the parameter value determining module includes: a sample information obtaining module configured to obtain sample configuration information for particle display, the sample configuration information comprising corresponding sample parameter values of the set of configuration parameters; an indication information obtaining module configured to obtain illustrative information for the set of configuration parameters, the illustrative information indicating corresponding meanings of the set of configuration parameters in natural language; and a parameter value generating module configured to generate, by using a machine learning model configured for semantic analysis, a parameter value of the at least one configuration parameter based on the sample configuration information, the illustrative information, and the description text.

In some embodiments, the set of configuration parameters comprises a numerical parameter having a parameter value of numerical value, and the illustrative information comprises at least one of the following: a value range of the parameter value of the numerical parameter, or text semantics corresponding to a plurality of different parameter values of the numerical parameter.

In some embodiments, the set of configuration parameters comprises at least one of the following: the number of particles, a size of a single particle, a duration of a particle being displayed, a mass of a particle, a color of a particle, a degree of luminescence of a particle, a size of a luminous area of a particle, or a duration of the particle display effect in the media content.

In some embodiments, the input information comprises description information related to an appearance of the target object, and the information obtaining module 610 includes: a description information receiving module configured to receive the description information; and an appearance information generating module configured to generate, based at least on the description information, three-dimensional appearance information of the target object represented by a three-dimensional grid.

In some embodiments, the appearance information generating module includes: an initial information generating module configured to generate initial appearance information of the target object represented by a three-dimensional grid by using a grid generation model corresponding to the type of the description information; a post-process module configured to perform one or more post-processes associated with content creation on the initial appearance information; and an appearance information determining module configured to determine post-processed initial appearance information as the three-dimensional appearance information.

In some embodiments, the post-process module includes: an option display module configured to display options for candidate post-processes associated with content creation, the candidate post-processes comprising the one or more post-processes; an input receiving module configured to receive a user input indicating the one or more post-processes; and a post-process execution module configured to, in response to the user input, performing the one or more post-processes on the initial appearance information.

In some embodiments, the description information comprises at least one of the following: a pattern depicting the target object, the pattern comprising one or more lines, characters describing the target object, or an image comprising the target object.

The units and/or modules included in the apparatus 600 may be implemented with various manners, including software, hardware, firmware, or any combination thereof. In some embodiments, one or more units and/or modules may be implemented using software and/or firmware, such as machine-executable instructions stored on a storage medium. In addition to or in lieu of machine-executable instructions, some or all of the units and/or modules in the device 600 may be implemented, at least in part, by one or more hardware logic components. As an example and not as a limitation, exemplary types of hardware logic components that may be used include field programmable gate arrays (FPGAs), application-specific integrated circuits (ASICs), application-specific standard products (ASSPs), systems-on-chip (SOCs), complex programmable logic devices (CPLDs), and the like.

FIG. 7 illustrates a block diagram of an electronic device 700 in which one or more embodiments of the present disclosure can be implemented. It should be understood that the electronic device 700 shown in FIG. 7 is only illustrative and should not constitute any limitation on the functionality and scope of the embodiments described herein. The electronic device 700 shown in FIG. 7 may be used to implement a terminal device 110 and/or a server 130 of FIG. 1.

As shown in FIG. 7, the electronic device 700 is in the table of a general electronic device. The components of the electronic device 700 may include, but are not limited to, one or more processors or processing units 710, a memory 720, a storage device 730, one or more communication units 740, one or more input devices 750, and one or more output devices 760. The processing units 710 may be actual or virtual processors and can execute various processes according to the programs stored in the memory 720. In a multiprocessor system, multiple processing units execute computer executable instructions in parallel to improve the parallel processing capability of the electronic device 700.

The electronic device 700 typically includes a variety of computer storage media. Such media can be any available media that is accessible to the electronic device 700, including but not limited to volatile and non-volatile media, removable and non-removable media. The memory 720 can be volatile memory (such as registers, caches, random access memory (RAM)), nonvolatile memory (such as a read-only memory (ROM), an electrically erasable programmable read-only memory (EEPROM), a flash memory), or some combination thereof. The storage device 730 can be any removable or non-removable medium, and can include machine-readable medium, such as a flash drive, a disk, or any other medium which can store information and/or data and can be accessed within the electronic device 700.

The electronic device 700 may further include additional removable/non-removable, volatile/non-volatile storage medium. Although not shown in FIG. 7, a disk driver for reading from or writing to a removable, non-volatile disk (such as a ‘floppy disk’), and an optical disk driver for reading from or writing to a removable, non-volatile optical disk can be provided. In these cases, each driver may be connected to the bus (not shown) by one or more data medium interfaces. The memory 720 can include a computer program product 725, which includes one or more program modules configured to execute various methods or actions of the various embodiments disclosed in this specification.

The communication unit 740 implements communication with other electronic devices via a communication medium. In addition, functions of components in the electronic device 700 may be implemented by a single computing cluster or multiple computing machines, which can communicate through a communication connection. Therefore, the electronic device 700 may be operated in a networking environment using a logical connection with one or more other servers, a network personal computer (PC), or another network node.

The input device 750 may be one or more input devices, such as a mouse, a keyboard, a trackball, etc. The output device 760 may be one or more output devices, such as a display, a speaker, a printer, etc. The electronic device 700 may also communicate with one or more external devices (not shown) through the communication unit 740 as required. The external device, such as a storage device, a display device, etc., communicate with one or more devices that enable users to interact with the electronic device 700, or communicate with any device (for example, a network card, a modem, etc.) that makes the electronic device 700 communicate with one or more other computing devices. Such communication may be executed via an input/output (I/O) interface (not shown).

According to example implementation of the present disclosure, there is provided a computer-readable storage medium on which a computer-executable instruction or computer program is stored, wherein the computer-executable instructions are executed by a processor to implement the methods described above. According to example embodiments of the present disclosure, a computer program product is provided which is tangibly stored in a computer storage medium and includes computer-executable instructions, the computer-executable instructions, when executed by a device, cause the device to perform the methods described above.

Various aspects of the present disclosure are described in this specification with reference to the flow chart and/or the block diagram of the method, the device, the apparatus and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be executed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings display the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed in this specification.

1. A method of a media content generation, comprising:
obtaining, based on input information indicating a target object, appearance information of the target object, the appearance information at least indicating a shape and a posture of the target object;
receiving a description text related to a particle display effect;
determining, based on the description text, configuration information for particle display of the target object; and
generating, based on the appearance information and the configuration information, a media content comprising a particle effect of the target object.

2. The method of claim 1, wherein determining the configuration information comprises:
obtaining a set of configuration parameters for the particle display effect; and
determining, by performing a semantic analysis on the description text, a parameter value of at least one configuration parameter in the set of configuration parameters.

3. The method of claim 2, wherein determining the parameter value of at least one configuration parameter of the set of configuration parameters comprises:
obtaining sample configuration information for particle display, the sample configuration information comprising corresponding sample parameter values of the set of configuration parameters;
obtaining illustrative information for the set of configuration parameters, the illustrative information indicating corresponding meanings of the set of configuration parameters in natural language; and
generating, by using a machine learning model configured for semantic analysis, a parameter value of the at least one configuration parameter based on the sample configuration information, the illustrative information, and the description text.

4. The method of claim 3, wherein the set of configuration parameters comprises a numerical parameter having a parameter value of numerical value, and the illustrative information comprises at least one of the following:
a value range of the parameter value of the numerical parameter, or
text semantics corresponding to a plurality of different parameter values of the numerical parameter.

5. The method of claim 2, wherein the set of configuration parameters comprises at least one of the following:
the number of particles,
a size of a single particle,
a duration of a particle being displayed,
a mass of a particle,
a color of a particle,
a degree of luminescence of a particle,
a size of a luminous area of a particle, or
a duration of the particle display effect in the media content.

6. The method of claim 1, wherein the input information comprises description information related to an appearance of the target object, and obtaining the appearance information of the target object comprises:
receiving the description information; and
generating, based at least on the description information, three-dimensional appearance information of the target object represented by a three-dimensional grid.

7. The method of claim 6, wherein generating the three-dimensional appearance information comprises:
generating initial appearance information of the target object represented by a three-dimensional grid by using a grid generation model corresponding to the type of the description information;
performing one or more post-processes associated with content creation on the initial appearance information; and
determining post-processed initial appearance information as the three-dimensional appearance information.

8. The method of claim 7, wherein performing one or more post-processes associated with content creation on the initial appearance information comprises:
displaying options for candidate post-processes associated with content creation, the candidate post-processes comprising the one or more post-processes;
receiving a user input indicating the one or more post-processes; and
in response to the user input, performing the one or more post-processes on the initial appearance information.

9. The method of claim 6, wherein the description information comprises at least one of the following:
a pattern depicting the target object, the pattern comprising one or more lines,
characters describing the target object, or
an image comprising the target object.

10. An electronic device, comprising:
at least one processing unit; and
at least one memory coupled to the at least one processing unit and storing instructions for execution by the at least one processing unit, the instructions, when executed by the at least one processing unit, causing the electronic device to perform the acts comprising:
obtaining, based on input information indicating a target object, appearance information of the target object, the appearance information at least indicating a shape and a posture of the target object;
receiving a description text related to a particle display effect;
determining, based on the description text, configuration information for particle display of the target object; and
generating, based on the appearance information and the configuration information, a media content comprising a particle effect of the target object.

11. The electronic device of claim 10, wherein determining the configuration information comprises:
obtaining a set of configuration parameters for the particle display effect; and
determining, by performing a semantic analysis on the description text, a parameter value of at least one configuration parameter in the set of configuration parameters.

12. The electronic device of claim 11, wherein determining the parameter value of at least one configuration parameter of the set of configuration parameters comprises:
obtaining sample configuration information for particle display, the sample configuration information comprising corresponding sample parameter values of the set of configuration parameters;
obtaining illustrative information for the set of configuration parameters, the illustrative information indicating corresponding meanings of the set of configuration parameters in natural language; and
generating, by using a machine learning model configured for semantic analysis, a parameter value of the at least one configuration parameter based on the sample configuration information, the illustrative information, and the description text.

13. The electronic device of claim 12, wherein the set of configuration parameters comprises a numerical parameter having a parameter value of numerical value, and the illustrative information comprises at least one of the following:
a value range of the parameter value of the numerical parameter, or
text semantics corresponding to a plurality of different parameter values of the numerical parameter.

14. The electronic device of claim 11, wherein the set of configuration parameters comprises at least one of the following:
the number of particles,
a size of a single particle,
a duration of a particle being displayed,
a mass of a particle,
a color of a particle,
a degree of luminescence of a particle,
a size of a luminous area of a particle, or
a duration of the particle display effect in the media content.

15. The electronic device of claim 10, wherein the input information comprises description information related to an appearance of the target object, and obtaining the appearance information of the target object comprises:
receiving the description information; and
generating, based at least on the description information, three-dimensional appearance information of the target object represented by a three-dimensional grid.

16. The electronic device of claim 15, wherein generating the three-dimensional appearance information comprises:
generating initial appearance information of the target object represented by a three-dimensional grid by using a grid generation model corresponding to the type of the description information;
performing one or more post-processes associated with content creation on the initial appearance information; and
determining post-processed initial appearance information as the three-dimensional appearance information.

17. The electronic device of claim 16, wherein performing one or more post-processes associated with content creation on the initial appearance information comprises:
displaying options for candidate post-processes associated with content creation, the candidate post-processes comprising the one or more post-processes;
receiving a user input indicating the one or more post-processes; and
in response to the user input, performing the one or more post-processes on the initial appearance information.

18. The electronic device of claim 15, wherein the description information comprises at least one of the following:
a pattern depicting the target object, the pattern comprising one or more lines,
characters describing the target object, or
an image comprising the target object.

19. A non-transitory computer-readable storage medium having a computer program stored thereon, the computer program being executable by a processor to implement the acts comprising:
obtaining, based on input information indicating a target object, appearance information of the target object, the appearance information at least indicating a shape and a posture of the target object;
receiving a description text related to a particle display effect;
determining, based on the description text, configuration information for particle display of the target object; and
generating, based on the appearance information and the configuration information, a media content comprising a particle effect of the target object.

20. The medium of claim 19, wherein determining the configuration information comprises:
obtaining a set of configuration parameters for the particle display effect; and
determining, by performing a semantic analysis on the description text, a parameter value of at least one configuration parameter in the set of configuration parameters.
